(19) United States
(12) Patent Application Publication
(10) Pub. No.: US 2005/0212846 A1
(43) Pub. Date: Sep. 29, 2005

(54) Apparatus for ejecting liquid drops and a method of detecting abnormal ejection of a head for ejecting liquid drops

(76) Inventors: Osamu Shinkawa, Chino (JP); Yusuke Sakagami, Shiojiri (JP); Hiroyuki Ishikawa, Shiojiri (JP); Shogo Nakajima, Suwa (JP)

Correspondence Address: HARNESS, DICKEY & PIERCE, P.L.C., P.O. BOX 828, BLOOMFIELD HILLS, MI, 48303, US

(21) Appl. No.: 11/089,355

(22) Filed: Mar. 24, 2005

(30) Foreign Application Priority Data
Mar. 26, 2004 (JP) 2004-092355
May 28, 2004 (JP) 2004-159365

(51) Int. Cl. B41J 29/393

(52) U.S. Cl. 347/19; 347/81

(57) ABSTRACT

An apparatus is provided for ejecting liquid drops while eliminating a special sensor (a photosensor) and improve detection accuracy for abnormal ink drop ejection. When the detecting an abnormal ink drop ejection, a drive circuit outputs an actuator-driving voltage in addition to an original drive voltage with a contact of a changeover switch located in a first position. The original drive voltage causes the electrostatic actuator to be driven. Thus, the vibrating plate is vibrated, whereby ink drops are ejected. Thereafter, the electrostatic actuator is charged with a charge according to the actuator-driving voltage. The charging voltage corresponds to the residual vibration of the vibrating plate. Then, the contact of the changeover switch is switched to a residual vibration-detecting circuit. Thus, the residual vibration-detecting circuit is supplied with the charging voltage to thereby output a residual vibration waveform.

### RELATED APPLICATIONS

This application claims priority to Japanese Patent Application Nos. 2004-092355 filed Mar. 26, 2004 and 2004-159365 filed May 28, 2004 which are hereby expressly incorporated by reference herein in their entirety.

### BACKGROUND

1. Technical Field

The present invention relates to an apparatus for ejecting liquid drops such as an ink-jet printer, and a method of detecting abnormal ejection of its head for ejecting liquid drops.

2. Related Art

An ink-jet printer, one of apparatuses for ejecting liquid drops, has a plurality of nozzles, from which ink drops (liquid drops) are ejected thereby to form an image on a predetermined sheet. An ink-jet head (or a print head) of an ink-jet printer is provided with a lot of nozzles, some of them are occasionally plugged and rendered incapable of ejecting ink drops owing to an increase in the viscosity of the ink, the entry of gas bubbles, adhesion of dust, paper powder, etc. and other factors. Nozzle plugging produces images with missing dots and has an adverse effect on image quality.

As an apparatus for checking ink drop ejection for the purpose of eliminating such disadvantage, conventionally there has been known an apparatus which has a light-emitting element and a light-receiving element, which are so provided that a nozzle for ejecting ink drops is located between them, and which detects variations in light intensity resulting from ink drops passing therebetween with the elements thereby to determine the operating state of each nozzle (e.g. see Patent Document, JP-A-2002-192740).

However, a conventional apparatus which optically detects ink drop ejection from each nozzle has disadvantages as follows.

That is, one is a space for placing a photosensor is required, and another is it is needed to increase the accuracies in association with the place where an ink drop passing through a light-receivable region is detected and the timing of the detection, in order to detect minute ink drops with a high sensitivity.

In consideration of the foregoing, the invention was made. Therefore, it is an object of the invention to provide an apparatus for ejecting liquid drops, which doesn't need any particular sensor such as a photosensor and which can improve the reliability of the accuracy for detecting abnormal ejection of ink drops even with a relatively simple configuration. Also, it is another object of the invention to provide a method of detecting abnormal ejection of a head for ejecting liquid drops.

### SUMMARY

In order to solve the problems and achieve the above objects, the invention is arranged as follows.

A first mode of the invention includes: a head for ejecting liquid drops having
a vibrating plate,
an electrostatic actuator for displacing the vibrating plate, the actuator including the vibrating plate,
a cavity filled with a liquid and having an internal pressure increased and decreased according to a displacement of the vibrating plate, and
a nozzle in communication with the cavity for ejecting the liquid as liquid drops in response to an increase and a decrease in the internal pressure;
a driving unit for outputting a predetermined drive signal for driving the electrostatic actuator;
a residual vibration-detecting unit for detecting a residual vibration of the vibrating plate by a terminal voltage of the electrostatic actuator; and
a connection-switching unit for connecting the electrostatic actuator to the driving unit to allows the driving unit to drive the electrostatic actuator and switching a connection target of the electrostatic actuator from the driving unit to the residual vibration-detecting unit with a charging voltage remaining in the electrostatic actuator.

A second mode of the invention is the first mode wherein the drive signal output by the driving unit contains an actuator-charging signal for charging the electrostatic actuator, the actuator-charging signal output subsequently to the original drive signal in addition to an original drive signal for driving the electrostatic actuator.

A third mode of the invention is the second aspect, wherein the connection-switching unit is composed of an analog switch, and when a detection process of ejection failure of the nozzle is performed, the driving unit sequentially outputs the original drive signal and the actuator-charging signal with the analog switch connecting the electrostatic actuator to the driving unit, and then the analog switch switches the connection target of the electrostatic actuator from the driving unit to the residual vibration-detecting unit with a predetermined timing thereby to allow a charge to remain in the electrostatic actuator.

A fourth mode of the invention is the first mode wherein the connection-switching unit selectively establishes one of a connection between the electrostatic actuator and the driving unit and a connection between the electrostatic actuator and the residual vibration-detecting unit, and
the connection-switching unit includes a resistor element connected in series with the electrostatic actuator.

A fifth mode of the invention is the fourth mode, wherein when a detection process of ejection failure of the nozzle is performed, the driving unit outputs the drive signal through the resistor element to the electrostatic actuator with the connection-switching unit connecting the electrostatic actuator to the driving unit, thereby to cause the electrostatic actuator to be charged and discharged with a time constant depending on a resistance value of the resistor element and a capacitance value of the electrostatic actuator, and
the connection-switching unit switches the connection target of the electrostatic actuator from the driving unit to the residual vibration-detecting unit with a timing concurrently with termination of output of the drive signal thereby to allow a charge to remain in the electrostatic actuator.

A sixth mode of the invention is the fourth or fifth mode, wherein the connection-switching unit is composed of an analog switch, and
the resistor element makes a resistance when the analog switch is conducting.

A seventh mode of the invention is any one of the first to sixth modes, wherein a change in charging voltage of the electrostatic actuator is induced by the charge remaining in an electrostatic actuator and a capacitance of the electrostatic actuator changed according to the displacement of the vibrating plate, and
the residual vibration-detecting unit detects a residual vibration of the vibrating plate based on the induced change in the charging voltage.

An eighth mode of the invention includes the steps of:
performing an operation of ejecting a liquid in a cavity as liquid drops through a nozzle by driving an electrostatic actuator including a vibrating plate with a drive signal and vibrating the vibrating plate;
thereafter, with a charging voltage remaining in the electrostatic actuator, detecting a residual vibration of the vibrating plate by the charging voltage; and
detecting abnormal ejection of the liquid drops based on the detected residual vibration.

A ninth mode of the invention includes the steps of:
performing an operation of ejecting a liquid in a cavity as liquid drops through a nozzle by driving an electrostatic actuator including a vibrating plate with a drive signal and vibrating the vibrating plate;
immediately thereafter, supplying an actuator-charging signal to the electrostatic actuator for a predetermined time;
thereafter, inducing a change in charging voltage of the electrostatic actuator by a charge remaining in the electrostatic actuator and a capacitance of the electrostatic actuator changed according to a displacement of the vibrating plate;
detecting a residual vibration of the vibrating plate based on the induced change in the charging voltage; and
detecting abnormal ejection of the liquid drops based on the detected residual vibration.

A tenth mode of the invention is a method of detecting abnormal ejection of a head for ejecting liquid drops, including the steps of:
ejecting a liquid in a cavity as liquid drops through a nozzle by driving an electrostatic actuator including a vibrating plate with a drive signal and vibrating the vibrating plate;
applying the drive signal through a resistor element to the electrostatic actuator thereby to charge and discharge the electrostatic actuator;
inducing a charge in charging voltage of the electrostatic actuator by a charge remaining in the electrostatic actuator before completion of the discharge and a capacitance of the electrostatic actuator changed according to a displacement of the vibrating plate;
detecting a residual vibration of the vibrating plate based on the induced change of the charging voltage; and
detecting abnormal ejection of the liquid drops based on the detected residual vibration.

The invention having any one of the arrangements can eliminate the need for a special sensor such as a photosensor and improve the reliability of detection accuracy for abnormal ink drop ejection even with its relatively simple arrangement.

### BRIEF DESCRIPTION OF THE DRAWINGS

FIG. 1 is a plan view schematically showing an arrangement of an ink-jet printer as an apparatus for ejecting liquid drops of the first embodiment of the invention.

FIG. 2 is a sectional view showing an arrangement of a head unit of the ink-jet printer illustrated in FIG. 1.

FIG. 3 is a plan view showing an arrangement of a nozzle board of the head unit illustrated in FIG. 2.

FIG. 4 is a circuit diagram showing a simple harmonic motion computational model assuming the residual vibration of the vibrating plate illustrated in FIG. 2.

FIG. 5 is a view showing examples of the experimental results in association with the detected waveforms of residual vibrations of the vibrating plate illustrated in FIG. 2, in which a normal case and abnormal cases are illustrated.

FIG. 6 is a view of assistance in explaining the principle for detecting residual vibrations of the vibrating plate in association with the invention.

FIG. 7 is a block diagram showing an arrangement of the apparatus for ejecting liquid drops of the first embodiment of the invention.

FIG. 8 is a circuit diagram showing a specific arrangement of the drive circuit illustrated in FIG. 7.

FIG. 9 is a block diagram showing a specific arrangement of the residual vibration-detecting circuit illustrated in FIG. 7.

FIG. 10 is a circuit diagram of the changeover switch illustrated in FIG. 7, which is composed of an analog switch.

FIGS. 11A-11C are waveform illustrations showing exemplary waveforms at the constituent features in the first embodiment illustrated in FIG. 7.

FIG. 12 is a flowchart of assistance in explaining a detection operation executed when the apparatus for ejecting liquid drops of the first embodiment illustrated in FIG. 7 performs the detection of the residual vibration.

FIG. 13 is a block diagram showing an arrangement of an apparatus for ejecting liquid drops according to the second embodiment of the invention.

FIGS. 14A-14C are waveform illustrations showing exemplary waveforms at the constituent features in the second embodiment illustrated in FIG. 13.

FIG. 15 It is a flowchart of assistance in explaining a detection operation executed when the apparatus for ejecting liquid drops of the second embodiment illustrated in FIG. 13 performs the detection of the residual vibration.

### DETAILED DESCRIPTION

The embodiments of an apparatus for ejecting liquid drops and a method of detecting abnormal ejection of a head for ejecting liquid drops according to the invention will be described below in reference to the drawings.

### First Embodiment

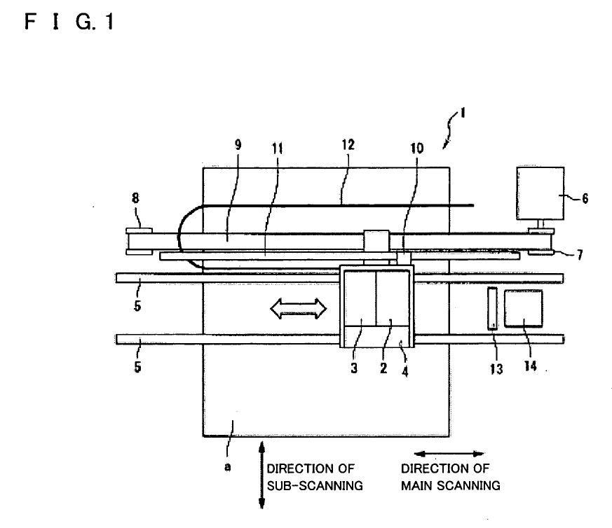

FIG. 1 is a plan view schematically showing an arrangement of an ink-jet printer 1 as an apparatus for ejecting liquid drops of the first embodiment of the invention.

The ink-jet printer 1 includes a carriage 4 with a head unit 2 and an ink cartridge 3 as shown in FIG. 1, and is arranged so that the carriage 4 can be moved in a direction of main scanning while being guided by a set of carriage shafts 5. The carriage 4 is partially secured to a toothed belt 9. The toothed belt 9 is mounted around and stretched between a driving pulley 7 secured to a rotating shaft of a motor 6 and a driven pulley 8.

Also, the carriage 4 is mounted with an encoder 10. Along a direction of movement of the carriage 4, there is provided a linear scale 11. Hence, the location of the head unit 2 on the carriage 4 can be detected through the encoder 10.

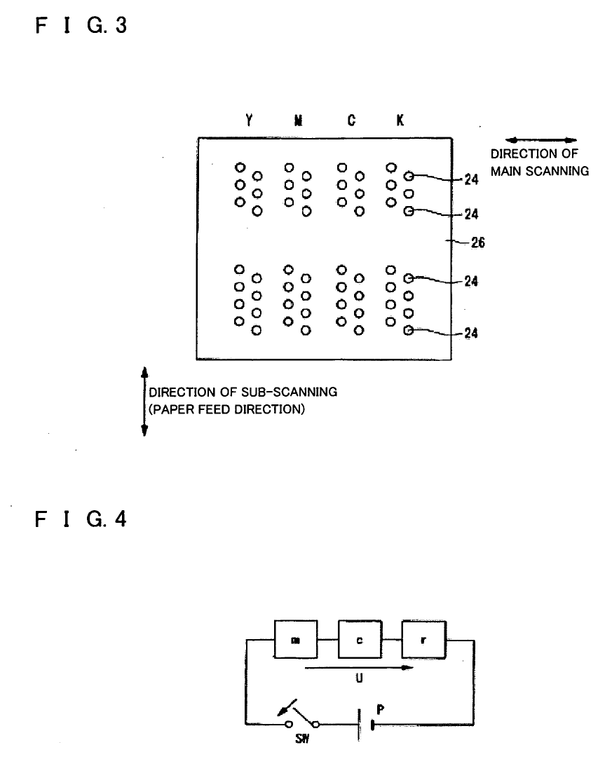

In FIG. 1, the reference numeral 12 indicates a cable for electrically connecting the head unit 2 to a system controller, etc. The numeral 13 indicates a wiper for cleaning a ink-jet head surface, which is to be described later. The numeral 14 indicates a cap to cap a nozzle board of the ink-jet head (see FIG. 3).

In the ink-jet printer 1 as arranged above, when a signal detected by the encoder 10 is entered into a motor control circuit (not shown), the motor control circuit controls the rotating operation of the motor 6 as follows. That is, the rotating operation is controlled so as to be accelerated, kept at a constant speed, decelerated, reversed, accelerated, kept at a constant speed, decelerated, reversed, . . . .

The carriage 4 is repeatedly reciprocated in the direction of main scanning while the motor 6 is operated in this manner. The period during which the motor 6 is operated at a constant speed corresponds to a field for printing, and therefore ink drops from a nozzle of the head unit 2 carried on the carriage 4 are ejected onto a recording sheet “a” during the period of the constant speed. As a result, on the recording sheet “a” is recorded a predetermined character or image through the ink drops.

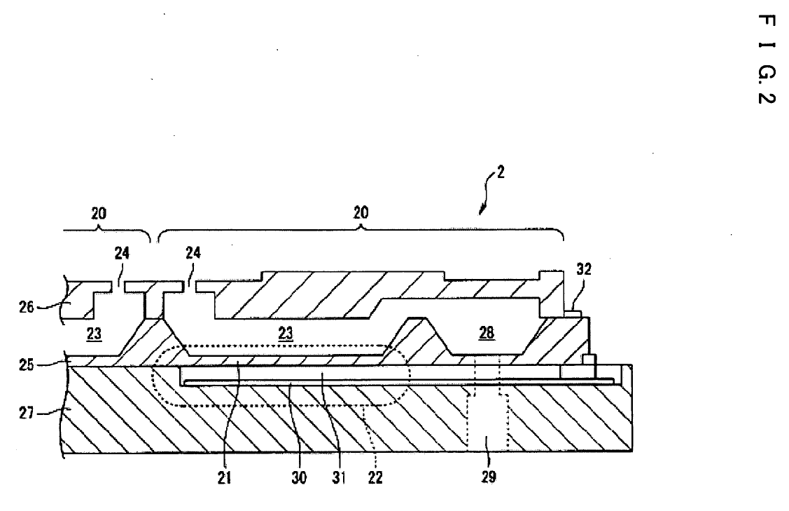

Next, a specific arrangement of the head unit 2 shown in FIG. 1 will be described in reference to FIGS. 2 and 3.

As shown in FIG. 2, the head unit 2 includes a lot of ink-jet heads (heads for ejecting liquid drops) 20, wherein each ink-jet head 20 incorporates an electrostatic actuator.

As shown in FIG. 2, the ink-jet heads 20 each include at least: a vibrating plate 21; an electrostatic actuator 22 for displacing the vibrating plate 21, which includes the vibrating plate 21; a cavity (pressurized space) 23 filled with a liquid ink, the internal pressure of which is increased and decreased depending on the displacement of the vibrating plate 21; and a nozzle 24 in communication with the cavity 23 for ejecting the ink as liquid drops depending on the increase and decrease in the pressure in the cavity 23.

The head unit 2 is, further in detail, structured into a three-layer structure, wherein a glass board 27 as its lower layer, a silicon board 25 located centrally, and a silicon nozzle board 26 as its upper layer are stacked. Between the centrally-located silicon board 25 and the upper nozzle board 26, a cavity 23 and a reservoir 28 in communication with the cavity are defined. Also, the reservoir 28 is in communication with an ink supply inlet 29 provided in the glass board 27.

Further, between the vibrating plate 21 constituting a part of the central silicon board 25 and serving as a bottom plate of the cavity 23 and an individual electrode 30 provided on the glass board 27, there are formed an interstice 31. The vibrating plate 21 is connected to a common electrode 32.

Therefore, the vibrating plate 21, the individual electrode 30, and the interstice 31 formed therebetween constitute the electrostatic actuator 22 as the main parts thereof. The actuator 22 is driven by a drive signal applied between the individual electrode 30 and the common electrode 32.

The nozzles 24, formed for each ink-jet head 20 in the nozzle board 26 shown in FIG. 2, are arrayed, for example, as illustrated in FIG. 3. The example of FIG. 3 shows an array pattern for the nozzles 24 in the case where four colors of ink (Y, M, C, K) are applied.

In an ink-jet printer 1 having ink-jet heads 20 like the foregoing ones can be caused abnormal ejection (or non-ejection) of ink drops, i.e. a so-called missing dot phenomenon, in which ink drops are not ejected from nozzles 24 when ink drops must be ejected owing to exhaustion of ink, generation of gas bubbles, plugging (drying), adhesion of paper powder, etc.

The paper powder herein cited is prone to be created when a recording sheet manufactured using wood pulp as a row material frictionally contacts with a paper feed roller, etc. Therefore, the paper powder means the fiber produced from a part of the recording sheet, and an aggregation thereof.

Next, the principle for detecting abnormal ejection of ink drops according to the invention will be described in reference to FIGS. 2, 4, and 5.

When a drive circuit, which is to be described later, supplies a drive signal to the electrostatic actuator 22 illustrated in FIG. 2, the vibrating plate 21 is attracted toward the individual electrode 30 by an electrostatic attraction force, whereby elastic energy is accumulated. When the supply of the drive signal is stopped, the elastic energy is released. In this process, the vibrating plate 21 is returned away from the individual electrode 30 thereby to increase the pressure in the cavity 23, and then the pressure is reduced. As a result of this, a part of the ink filled in the cavity 23 is ejected through the nozzle 24 in communication with the cavity 23 as ink drops.

A series of movements of the vibrating plate 21 as described above induces the free vibration of the vibrating plate 21 at a natural vibration frequency that is determined by an acoustic resistance r depending on the nozzle 24, ink supply inlet 29, the viscosity of the ink, etc., an inertance m depending on the weight of the ink in an ink passage, and a compliance c of the vibrating plate 21. The free vibration of the vibrating plate 21 is hereinafter referred to as residual vibration.

FIG. 4 shows a simple harmonic motion computational model assuming the residual vibration of the vibrating plate 21. From the calculation of the step response when an acoustic pressure P is applied to the computational model with respect to volume velocity u, the following expression can be obtained.

$$\begin{matrix}Equation 1 & \\ u = \frac{P}{ω \cdot m} {ⅇ}^{- ω t} \cdot sin ω t ( {m}^{3} \text{/} s ) & ( 1 ) \\ ω = \sqrt{\frac{1}{m \cdot C} - {α}^{2}} & ( 2 ) \\ α = \frac{r}{2 m} & ( 3 )\end{matrix}$$

Here, if the ink-jet head 20, which is illustrated in FIG. 2, ejects ink normally, and the acoustic resistance r, inertance m, and compliance c are unchanged, the residual vibration of the vibrating plate 21 would always produce a certain waveform.

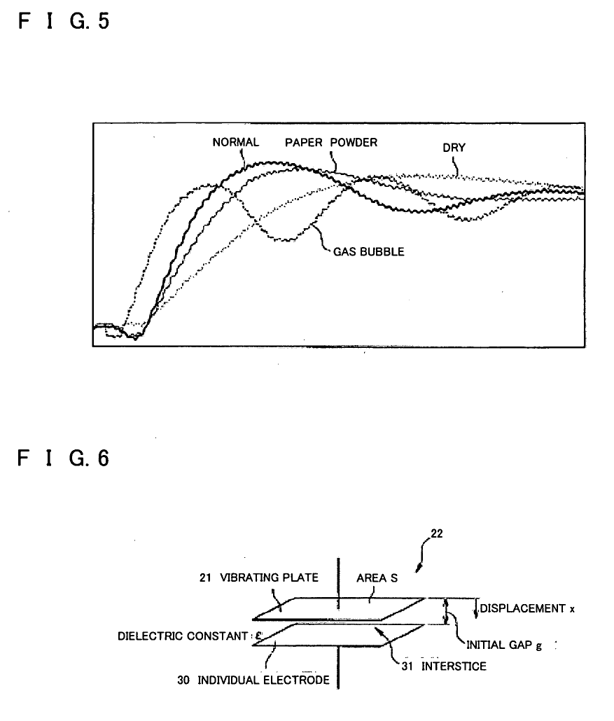

However, in the case where missing dots occur owing to defective ink ejection, the residual vibration of the vibrating plate 21 produces a waveform different from that in the normal condition. FIG. 5 shows examples of the experimental results in association with the detected waveforms of residual vibrations. From the experimental results and the simple harmonic motion computational model, the following have been shown.

In the case where gas bubbles plug up an ink passage or a leading end of a nozzle, the weight of ink is decreased according to the volume of the entered gas bubbles, thereby reducing the inertance m. Such gas bubbles realize a condition equivalent to the condition where the diameter of the nozzle is widened. As a result, a characteristic residual vibration waveform with a reduced acoustic resistance r and a higher frequency can be detected (see “GAS BUBBLE” in FIG. 5).

In the case where the ink has dried in a nozzle portion thereby to disable the nozzle from ejecting ink drops, such drying increases the viscosity of the ink in the vicinity of the nozzle and increases the acoustic resistance r, resulting in overdamping. Thus, a characteristic residual vibration waveform can be detected (see “DRY” in FIG. 5).

In the case where paper powder, foreign particles, etc. adhere to a nozzle surface, the paper powder causes the ink to ooze from the nozzle, thereby increasing the weight of the ink with respect to the vibrating plate and increasing the inertance m. Also, the fiber of the paper powder adhering to the nozzle increases the acoustic resistance r and therefore the period of vibration is increased in comparison to that in the case of normal ejection (i.e. the frequency is lowered). Thus, a characteristic residual vibration waveform can be detected (see “PAPER POWDER” in FIG. 5).

Therefore, utilizing the difference among residual vibrations of the vibrating plate 21 enables abnormal ink drop ejection of the ink-jet head 20 to be detected and allows the cause of the plugging to be identified.

According to the invention, abnormal ink drop ejection of ink-jet head 20 (or ejection failure of the nozzle) can be detected by detecting residual vibrations of the vibrating plate 21. The principle for detecting residual vibrations will be described in reference to FIG. 6.

Here, the electrostatic actuator 22 illustrated in FIG. 2 is regarded as a capacitor and its individual electrode 30 and vibrating plate 21 as parallel plates of the capacitor as illustrated in FIG. 6. Then, the residual vibration of the vibrating plate 21 causes the gap (interstice) of the capacitor to change and thus the capacitance C(x) of the capacitor changes according to Expression (4).

Meanwhile, immediately after the electrostatic actuator 22 is cut off from the drive circuit to be described later, i.e. just after the drive signal supply is stopped, an electric charge Q remains in the capacitor. Therefore, the charging voltage Vc of the capacitor changes according to the change of the capacitance C of the capacitor as shown by Expression (5), and the mechanical residual vibration of the vibrating plate 21 can be detected as a change of that voltage.

$$\begin{matrix}C ( x ) = ɛ \frac{S}{( g - x )} & ( 4 ) \\ V c = \frac{Q}{C ( x )} & ( 5 )\end{matrix}$$

Here, S is an area of each parallel plate of the capacitor, which is equivalent to the area of the vibrating plate 21 and the individual electrode 30; g is a distance (i.e. an initial gap) between them; e is a dielectric constant of the interstice 31; and x is an amount of displacement of the vibrating plate 21 relative to a reference position, which results from the residual vibration of the vibrating plate 21.

Next, an apparatus for ejecting liquid drops of the first embodiment of the invention will be described in reference to FIGS. 2 and 7-10, which is arranged based on the principle for detecting the residual vibration so that it can detect the residual vibration when the detection on abnormal ink drop ejection for the ink-jet heads 20 (i.e. missing dot for nozzles) must be done.

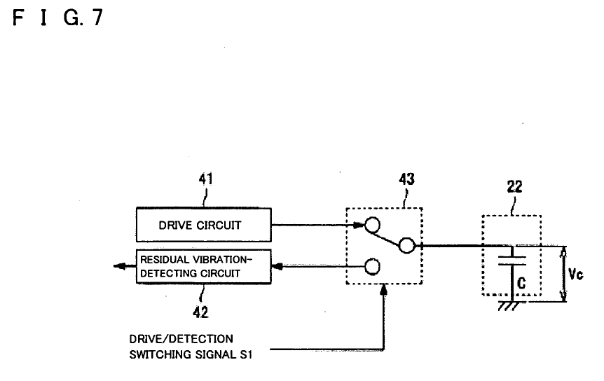

The apparatus for ejecting liquid drops of the first embodiment includes at least an electrostatic actuator 22, a drive circuit 41 used as a driving unit, a residual vibration-detecting circuit 42 used as a residual vibration-detecting unit, and a changeover switch 43 used as a connection-switching unit, as shown in FIG. 7.

As shown in FIG. 2, the electrostatic actuator 22 is provided for each ink-jet head 20, and has a vibrating plate 21, an individual electrode 30, and an interstice 31 formed between the plate and the electrode, as its main parts. The electrostatic actuator 22 can be represented by an equivalent capacitor. Therefore, in FIG. 7 the electrostatic actuator 22 is represented by a capacitor having a capacitance C. The capacitor has one electrode connected to a terminal of the changeover switch 43 and the other electrode grounded.

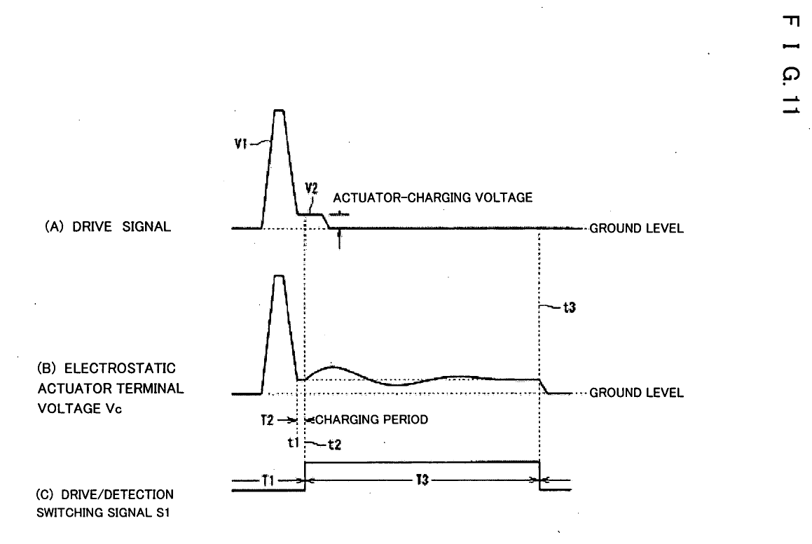

The drive circuit 41 is a circuit which outputs a drive signal (i.e. drive voltage) for driving the electrostatic actuator 22. The drive circuit is arranged so that it outputs a normal drive signal when an image is formed by ink drops, and outputs a drive signal as described later (see FIG. 11A) when the detection of abnormal ink drop ejection is carried out.

When the detection of abnormal ink drop ejection is performed, a changeover contact of the changeover switch 43 is switched to the residual vibration-detecting circuit 42. Then, the residual vibration-detecting circuit 42 detects a change in the charging voltage Vc of the equivalent capacitor of the electrostatic actuator 22 thereby to detect the residual vibration of the vibrating plate 21.

In other words, in the first embodiment, the charge remaining in the electrostatic actuator 22 and the capacitance of the electrostatic actuator 22 varied according to the displacement of the vibrating plate 21 induce a change in charging voltage of the electrostatic actuator 22. Then, the residual vibration-detecting circuit 42 detects the residual vibration of the vibrating plate 21 based on the induced change in charging voltage of the electrostatic actuator 22.

The contact of the changeover switch 43 usually serves to connect the electrostatic actuator 22 with the drive circuit 41 as shown in FIG. 7. When the detection of the abnormal ink drop ejection is performed, the system controller (not shown) outputs a drive/detection switching signal S1, and then the contact of the changeover switch 43 is switched from the drive circuit 41 to the residual vibration-detecting circuit 42.

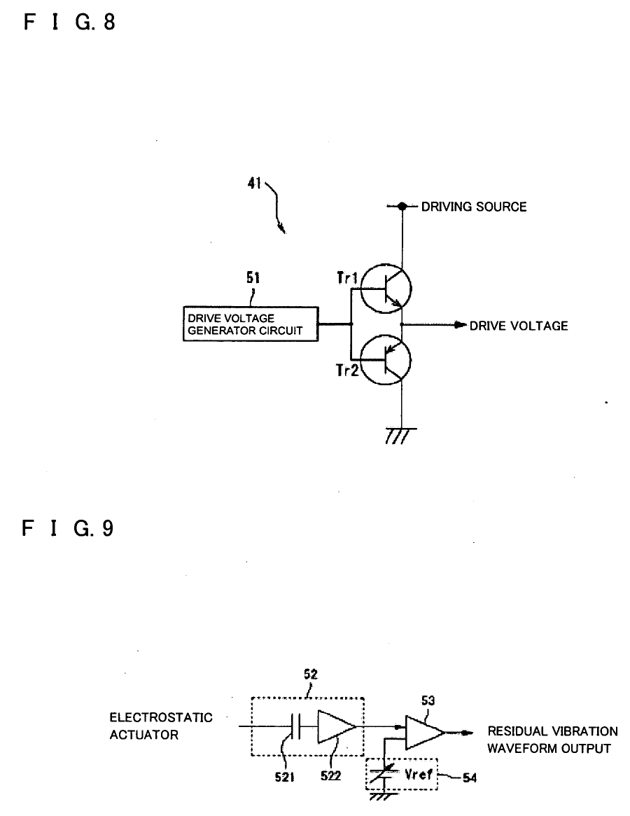

Now, the specific arrangement of the drive circuit 41 illustrated in FIG. 7 will be described in reference to FIG. 8.

The drive circuit 41 includes a drive voltage generator circuit 51, a current amplifier circuit composed of a combination of an NPN-type transistor Tr1 and a PNP-type transistor Tr2, as shown in FIG. 8.

The transistor Tr1 has a collector connected to a constant voltage power supply (i.e. driving source, not shown), a base connected to the output terminal of the drive voltage generator circuit 51, and an emitter connected to a terminal of the changeover switch 43. Thus, the transistor Tr1 is brought into conduction in response to a drive signal from the drive voltage generator circuit 51, whereby a drive voltage is supplied to the electrostatic actuator 22.

The transistor Tr2 has: an emitter connected to the emitter of the transistor Tr1 and to the terminal of the changeover switch 43; a base connected to the output terminal of the drive voltage generator circuit 51; and a collector connected to a ground. Thus, the transistor Tr2 is brought into conduction in response to a drive signal from the drive voltage generator circuit 51, whereby a charge in the electrostatic actuator 22 is discharged.

Next, an example of the specific arrangement of the residual vibration-detecting circuit 42 illustrated in FIG. 7 will be described in reference to FIG. 9.

The residual vibration-detecting circuit 42 includes an AC amplifier 52, a comparator 53, and a reference voltage generator circuit 54, as shown in FIG. 9.

The AC amplifier 52 amplifies AC components of a voltage that the electrostatic actuator 22 generates, i.e. AC components of a residual vibration waveform generated by a mechanical change of the vibrating plate 21. On this account, the AC amplifier 52 includes a capacitor 521 for cutting DC components contained in a voltage that the electrostatic actuator 22 generates, and an amplifier 522 for amplifying AC components after the capacitor 521 cuts DC components.

The comparator 53 compares an output voltage from the AC amplifier 52 with a reference voltage Vref generated by the reference voltage generator circuit 54. Based on the result of the comparison, the comparator 53 outputs a pulse waveform voltage as a waveform of the residual vibration. The reference voltage generator circuit 54 is a circuit for generating a reference voltage Vref to be supplied to the comparator 53. The reference voltage Vref that the generator circuit 54 generates may be of a fixed value, otherwise it may be variable so as to be set to an arbitrary value.

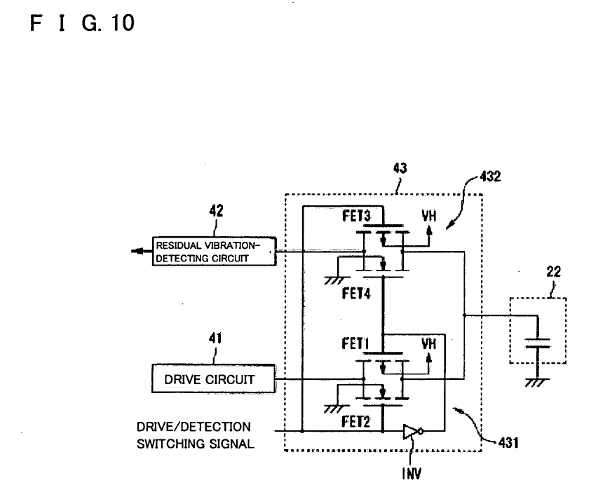

Now, the specific arrangement of the changeover switch 43 illustrated in FIG. 7 will be described in reference to FIG. 10.

As shown in FIG. 10, the changeover switch 43 is composed of an analog switch 431 for connecting the drive circuit 41 to the electrostatic actuator 22, and an analog switch 432 for connecting the residual vibration-detecting circuit 42 to the electrostatic actuator 22.

The reason for using the combination of the analog switches 431, 432 as the changeover switch 43 is that even their on-resistances don't particularly cause a problem on the driving operation of the electrostatic actuator 22 because of a small driving current required for driving the electrostatic actuator 22.

The analog switch 431 includes two transistors FET1 and FET2 connected and opposed to each other and an inverter INV. The analog switch 431 is arranged so that a drive/detection switching signal S1 from the system controller (not shown) is input to a gate of one transistor FET1 through the inverter INV and input directly to a gate of the other transistor FET2. Further, a drive signal output from the drive circuit 41 is input to sources of the two transistors FET1, FET2.

The analog switch 432 includes two transistors FET3 and FET4 connected and opposed to each other. The analog switch 432 is arranged so that a drive/detection switching signal S1 from the system controller is input directly to a gate of one transistor FET3 and input to a gate of the transistor FET4 through the inverter INV. Further, sources of the two transistors FET3, FET4 are connected to an input terminal of the residual vibration-detecting circuit 42.

The equivalent capacitor of the electrostatic actuator 22 has one electrode connected to drains of the transistors FET1, FET2, FET3, FET4 and the other electrode connected to a ground.

In the changeover switch 43 having such arrangement, the analog switch 432 operates so as to cut off the residual vibration-detecting circuit 42 from the electrostatic actuator 22 while the analog switch 431 connects the drive circuit 41 to the electrostatic actuator 22. Reversely, while analog switch 432 connects the residual vibration-detecting circuit 42 to the electrostatic actuator 22, the analog switch 431 operates so as to cut off the drive circuit 41 from the electrostatic actuator 22.

Since the analog switches 431, 432 have no directionality in their conducting directions, any of source or drain sides of the switches may be used to connect the electrostatic actuator 22 with the drive circuit 41 or residual vibration-detecting circuit 42.

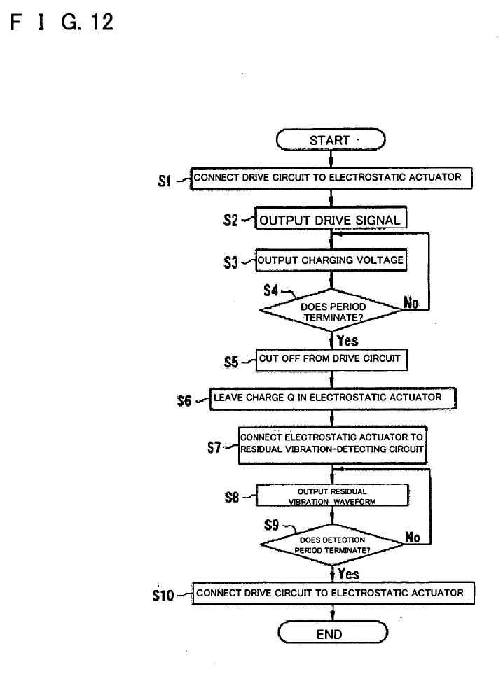

Next, examples of operations in association with the first embodiment having such arrangement will be described in reference to FIGS. 7, 11A-11C, 12 and the other drawing.

First, the operation executed when an image is formed on a recording sheet by ink drop ejection from the nozzle 24 of each ink-jet head 20 in the first embodiment will be described.

During this process, as shown in FIG. 7, a drive/detection switching signal S1 output by the system controller (not shown) remains at “L level.” Therefore, the contact of the changeover switch 43 stays in a position as illustrated in FIG. 7 and thus the connection between the drive circuit 41 and the electrostatic actuator 22 is maintained. Then, in this condition, a normal drive signal is output by the drive circuit 41 and as such, the electrostatic actuator 22 is driven by the drive signal. As a result, ink drops are ejected from the nozzle 24 of the ink-jet head 20 onto a recording sheet, whereby an image is formed.

After that, the apparatus for ejecting liquid drops of the first embodiment is to perform the detection of abnormal ejection for the nozzle 24 of each ink-jet head 20. Here will be presented a description focusing on the detection operation for residual vibration of the vibrating plate 21, which is to be executed in performing the detection of abnormal ejection.

Incidentally, such detection is carried out on an as-needed basis, as it is performed at the time of turning on the power source, or each time an image formation work for a predetermined number of pages is completed in the case where images are to be formed on a large number of recording sheets.

In the process of executing the detection, as shown in FIG. 11C, a drive/detection switching signal S1 output by the system controller is at “L level” during a connection period T1 of the drive circuit. Hence, the contact of the changeover switch 43 is in the position as illustrated in FIG. 7 during the period T1, and therefore the drive circuit 41 is connected to the electrostatic actuator 22 (Step S1).

In this situation, the drive circuit 41 outputs, for example, a drive signal as illustrated in FIG. 11A. The drive signal contains an actuator-charging voltage V2 in addition to an original drive voltage Vi used for ink drop ejection as shown in the drawing, in which the actuator-charging voltage is intended to charge the electrostatic actuator 22 for the purpose of detecting the residual vibration of the vibrating plate 21.

More specifically, a drive signal output by the drive circuit 41 consists of a drive voltage V1 output for ejecting liquid drops and an actuator-charging voltage V2 output subsequently to output of the drive voltage V1.

Hence, the drive circuit 41 first outputs a drive voltage V1 (Step S2), and subsequently outputs an actuator-charging voltage V2 (Step S3).

Thus, a terminal voltage Vc of the electrostatic actuator 22 according to a drive voltage V1, i.e. an output from the drive circuit 41 is, for example, as illustrated in FIG. 11B. As a result, the terminal voltage Vc causes the deflection of the vibrating plate 21 thereby to expand and reduce the volume of the cavity 23. In this period, the pressure produced in the cavity 23 causes a part of the ink filled in the cavity 23 to be ejected as ink drops through the nozzle 24 (see FIG. 2).

In this step, the drive voltage V1 is dropped sharply and as such, the terminal voltage Vc is also lowered sharply together with the drive voltage (see FIG. 11B). However, an actuator-charging voltage V2 is output subsequently to the output of the drive voltage V1. Hence, the terminal voltage Vc reaches a predetermined value according to the actuator-charging voltage V2, and the electrostatic actuator 22 is charged with the terminal voltage Vc for a charging period T2 from Time t1 to Time t2.

Thereafter, when the charging period T2 of the electrostatic actuator 22 is terminated at Time t2 as shown in FIGS. 11A-11C (Step S4), the drive/detection switching signal S1 from the system controller is turned from “L level” into “H level,” and then the period of the switching signal S1 moves into a detection period T3 (see FIG. 11C). As a result, the contact of the changeover switch 43 is switched from the position illustrated in FIG. 7 to the opposite position, whereby the drive circuit 41 is cut off from the electrostatic actuator 22 (Step S5).

At this time, a charge Q built up through the charging process during the charging period T2 remains in the electrostatic actuator 22 (Step S6). Therefore, the charging voltage (or terminal voltage) Vc of the capacitor in association with the electrostatic actuator 22 varies according to the change in capacitance C of the capacitor as illustrated in FIG. 11B and as such, a mechanical residual vibration of the vibrating plate 21 can be detected in the form of a voltage variation of the charging voltage Vc.

Also, at this time, the electrostatic actuator 22 is connected to the residual vibration-detecting circuit 42 after the switching operation of the contact of the changeover switch 43 (Step S7). Thus, the charging voltage (or terminal voltage) Vc of the capacitor is supplied to the residual vibration-detecting circuit 42. Then, the residual vibration-detecting circuit 42 outputs a residual vibration waveform depending on the residual vibration of the vibrating plate 21 (Step S8).

Here, the detection period T3 is a period during which the residual vibration of the vibrating plate 21 can be detected certainly. The detection period T3 can be set arbitrarily.

Then, when the detection period T3 has elapsed and the residual vibration-detecting circuit 42 has terminated the process for detecting the residual vibration of the vibrating plate 21 as shown in FIG. 11C (Step S9), namely at Time t3 the drive/detection switching signal S1 from the system controller is turned from “H level” into “L level.”

As a result of the change of the drive/detection switching signal S1 from “H level” to “L level,” the contact of the changeover switch 43 is turned back to the position illustrated in FIG. 7 thereby to connect the drive circuit 41 to the electrostatic actuator 22 (Step 10). This causes the charge Q remaining in the electrostatic actuator to be discharged through the drive circuit 41.

The residual vibration waveform detected by the residual vibration-detecting circuit 42 in the above way is supplied to a waveform-judging circuit (not shown) connected in a stage subsequent to the circuit 42. Then, the waveform-judging circuit judges the presence or absence of abnormal ink drop ejection based on the residual vibration waveform, and identifies the detail of the abnormality (i.e. the cause of ink plugging) when an abnormality is judged to be present.

As described above, according to the first embodiment of the invention, in the case where the detection of abnormal ejection of the nozzle 24 of the ink-jet head 20 is to be performed, a charge is left in the electrostatic actuator 22 after the operation of ejecting ink drops, thereby making it possible to detect the change of the residual vibration of the vibrating plate 21. Thus, abnormal ejection (missing dot) can be detected.

Therefore, the first embodiment can eliminate the need for a special sensor such as a photosensor and improve the reliability of detection accuracy for abnormal ink drop ejection even with its relatively simple arrangement.

### Second Embodiment

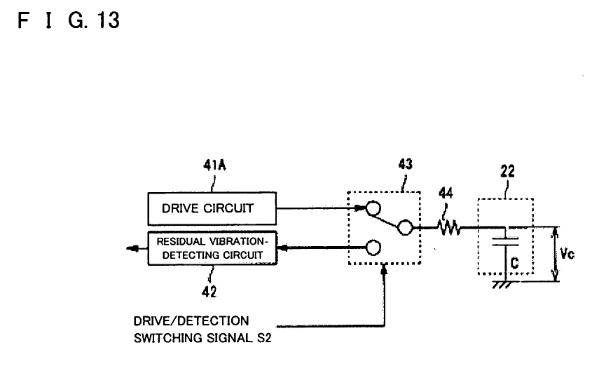

Now, an apparatus for ejecting liquid drops of the second embodiment of the invention will be described in reference to FIGS. 2 and 13, which is arranged based on the principle for detecting residual vibrations as described above so that it can detect the residual vibration when the detection on abnormal ink drop ejection for the ink-jet heads 20 must be done.

The apparatus for ejecting liquid drops of the second embodiment includes at least an electrostatic actuator 22, a drive circuit 41A used as a driving unit, a residual vibration-detecting circuit 42 used as a residual vibration-detecting unit, a changeover switch 43 used as a connection-switching unit, and a resistor element 44 included in the changeover switch 43 and connected in series with the electrostatic actuator 22 as shown in FIG. 13.

As shown in FIG. 2, the electrostatic actuator 22 is provided for each ink-jet head 20, and has, as its main parts, a vibrating plate 21, an individual electrode 30, and an interstice 31 formed between the plate and the electrode, as described above. The electrostatic actuator 22 can be represented by an equivalent capacitor. Therefore, in FIG. 13 the electrostatic actuator 22 is represented by a capacitor having a capacitance C. The capacitor has one electrode connected through the resistor element 44 to a terminal of the changeover switch 43 and the other electrode grounded.

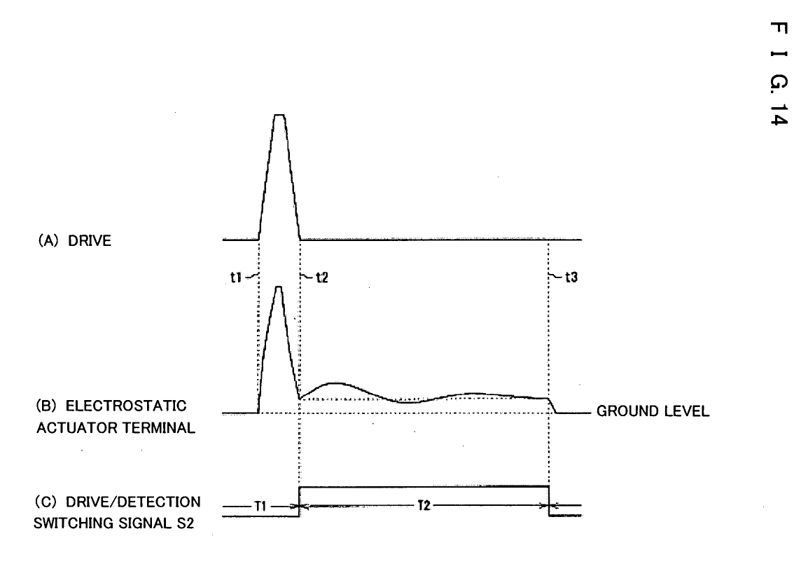

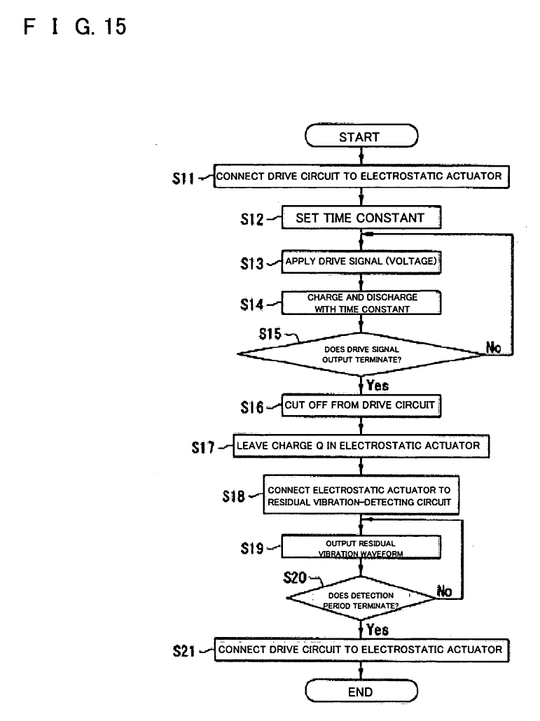

The drive circuit 41A is a circuit which outputs a drive signal (i.e. drive voltage) for driving the electrostatic actuator 22. The drive circuit is arranged so that it outputs drive signals as described later (see FIG. 14A) when an image is formed by ink drops, and when the detection of abnormal ink drop ejection is carried out respectively.

Here, the drive circuit 41A is basically arranged as is the drive circuit 41 of the first embodiment illustrated in FIG. 8. However, the drive circuit 41A differs from the drive circuit 41 in that a drive signal produced and output when the detection of abnormal ink drop ejection is performed has a waveform as shown in FIG. 11A in the case of the drive circuit 41 and has a waveform as shown in FIG. 14A in the case of the drive circuit 41A. Therefore, the drive circuit 41A of the second embodiment is different from the drive circuit 41 illustrated in FIG. 8 in the function of the drive voltage generator circuit 51.

The changeover switch 43 is usually in the condition where the contact of the switch connects between the electrostatic actuator 22 and the drive circuit 41A as shown in FIG. 13. However, when the detection of abnormal ink drop ejection is performed, the system controller (not shown) outputs a drive/detection switching signal S2, whereby the contact is switched from the drive circuit 41A to the residual vibration-detecting circuit 42.

Here, the changeover switch 43 is arranged as is the changeover switch 43 of the first embodiment illustrated in FIG. 10.

The resistor element 44 has one end connected to the changeover switch 43 and the other end connected to one electrode of the electrostatic actuator 22. Therefore, the electrostatic actuator 22 is charged and discharged through the resistor element 44 according to a drive signal from the drive circuit 41A. The speed of the charge and discharge depends on a time constant determined by the capacitance value of the electrostatic actuator 22 and the resistance value of the resistor element 44. Accordingly, the resistor element 44 has the function of slightly delaying the terminal voltage Vc of the electrostatic actuator 22 relative to a drive signal that the drive circuit 41A generates (see FIGS. 14A, 14B).

Here, even with the resistor element 44, that can never interfere with the driving operation of the electrostatic actuator 22 because of a small driving current required for driving the electrostatic actuator 22.

The resistance value of the resistor element 44 is previously set in a relation with respect to the capacitance C of the electrostatic actuator 22 so that a time constant which allows a charge to remain in the electrostatic actuator 22 can be obtained, provided that the charge is of a level which enables the residual vibration-detecting circuit 42 to detect a residual vibration-waveform with a timing for detection of residual vibrations as described later.

In the case where the changeover switch 43 is composed of an analog switch as illustrated in FIG. 10, the resistor element 44 may be replaced with a resistance developed in the analog switch in conduction. In addition, while the resistor element 44 may be incorporated in the changeover switch 43 as described above, the resistor element 44 may be connected in series between the changeover switch 43 and the electrostatic actuator 22 in fact.

When the detection of abnormal ink drop ejection is performed, a changeover contact of the changeover switch 43 is switched to the residual vibration-detecting circuit 42 according to a drive/detection switching signal S2. Then, the residual vibration-detecting circuit 42 detects a change in the charging voltage Vc of the equivalent capacitor of the electrostatic actuator 22 thereby to detect the residual vibration of the vibrating plate 21.

In other words, in the second embodiment, the charge remaining in the electrostatic actuator 22 as described later and the capacitance of the electrostatic actuator 22 varied according to the displacement of the vibrating plate 21 induce a change in charging voltage of the electrostatic actuator 22. Then, the residual vibration-detecting circuit 42 detects the residual vibration of the vibrating plate 21 based on the induced change in charging voltage of the electrostatic actuator 22.

Here, residual vibration-detecting circuit 42 is arranged as is the residual vibration-detecting circuit 42 of the first embodiment illustrated in FIG. 9.

Next, examples of operations in association with the second embodiment having such arrangement will be described in reference to FIGS. 13-15.

First, the operation executed when an image is formed on a recording sheet by ink drop ejection from the nozzle 24 of each ink-jet head 20 in the second embodiment will be described.

During this process, as shown in FIG. 13, a drive/detection switching signal S2 output by the system controller (not shown) remains at “L level.” Therefore, the contact of the changeover switch 43 is left fixed in a position as illustrated in FIG. 13 and thus the connection between the drive circuit 41A and the electrostatic actuator 22 is maintained. Then, in this condition, a drive signal as shown in FIG. 14A is output by the drive circuit 41A and as such, the electrostatic actuator 22 is driven by the drive signal. As a result, ink drops are ejected from the nozzle 24 of the ink-jet head 20 onto a recording sheet, whereby an image is formed.

After that, the apparatus for ejecting liquid drops of the second embodiment is to perform the detection of abnormal ejection for the nozzle 24 of each ink-jet head 20. Here will be presented a description focusing on the detection operation for residual vibration of the vibrating plate 21, which is to be executed in performing the detection of abnormal ejection.

Incidentally, such detection is carried out on an as-needed basis, as it is performed at the time of turning on the power source, or each time an image formation work for a predetermined number of pages is completed in the case where images are to be formed on a large number of recording sheets.

In the process of executing the detection, as shown in FIG. 14C, a drive/detection switching signal S2 output by the system controller is at “L level” during a connection period T1 of the drive circuit 41A. Hence, the contact of the changeover switch 43 is in the position as illustrated in FIG. 13 during the period T1, and therefore the drive circuit 41A is connected to the electrostatic actuator 22 (Step S11).

As a result of the connection, it becomes possible for the drive circuit 41A to charge and discharge the electrostatic actuator 22 with a predetermined time constant. In other words, this means that the time constant for charging and discharging the electrostatic actuator 22 has been set (Step S12).

In this condition, the drive circuit 41A outputs, for example, a drive signal as shown in FIG. 14A at Time t1, whereby a drive voltage is applied to the electrostatic actuator 22 (Step S13).

As a result, the terminal voltage Vc across the electrostatic actuator 22 is increased by charging as shown in FIG. 14B, and then decreased by discharging. In other words, the charge and discharge of the electrostatic actuator 22 are performed with a predetermined time constant (Step S14). The time constant, namely the speed of charge and discharge of the terminal voltage Vc across the electrostatic actuator 22 depends on the capacitance value of the electrostatic actuator 22 and the resistance value of the resistor element 44.

Hence, the waveform of the terminal voltage Vc across the electrostatic actuator 22 is slightly delayed relative to the waveform of a drive signal from the drive circuit 41A (see FIGS. 14A, 14B).

Thus, the terminal voltage Vc developed across the electrostatic actuator 22 causes the deflection of the vibrating plate 21 thereby to expand and reduce the volume of the cavity 23. In this period, the pressure produced in the cavity 23 causes a part of the ink filled in the cavity 23 to be ejected as ink drops through the nozzle 24 (see FIG. 2).

Thereafter, when the output of a drive signal from the drive circuit 41A is terminated at Time t2 as shown in FIGS. 14A-14C (Step S15), the drive/detection switching signal S2 from the system controller is turned from “L level” into “H level,” and then the period of the switching signal S2 moves into a detection period T2 (see FIG. 14C). As a result, the contact of the changeover switch 43 is switched from the position illustrated in FIG. 13 to the opposite position, whereby the drive circuit 41A is cut off from the resistor element 44 and the electrostatic actuator 22 (Step S16).

At this time, the terminal voltage Vc of the electrostatic actuator 22 doesn't reach the ground level with an accumulated charge remaining therein (Step S17). Therefore, the charging voltage (or terminal voltage) Vc of the capacitor in association with the electrostatic actuator 22 varies according to the change in capacitance C of the capacitor as illustrated in FIG. 14B and as such, a mechanical residual vibration of the vibrating plate 21 can be detected in the form of a voltage variation of the charging voltage Vc.

Also, at this time, the electrostatic actuator 22 is connected to the residual vibration-detecting circuit 42 after the switching operation of the contact of the changeover switch 43 (Step S18). Thus, the charging voltage (or terminal voltage) Vc of the capacitor is supplied to the residual vibration-detecting circuit 42. Then, the residual vibration-detecting circuit 42 outputs a residual vibration waveform depending on the residual vibration of the vibrating plate 21 (Step S19).

Here, the detection period T2 is a period during which the residual vibration of the vibrating plate 21 can be detected certainly. The detection period T2 can be set arbitrarily.

Then, when the detection period T2 has elapsed and the residual vibration-detecting circuit 42 has terminated the process for detecting the residual vibration of the vibrating plate 21 as shown in FIG. 14C (Step S20), namely at Time t3 the drive/detection switching signal S2 from the system controller is turned from “H level” into “L level.”

As a result of the change of the drive/detection switching signal S2 from “H level” to “L level,” the contact of the changeover switch 43 is turned back to the position illustrated in FIG. 13 thereby to connect the drive circuit 41A to the electrostatic actuator 22 (Step 21). This causes the charge Q remaining in the electrostatic actuator 22 to be discharged through the drive circuit 41A.

The residual vibration waveform detected by the residual vibration-detecting circuit 42 in the above way is supplied to a waveform-judging circuit (not shown) connected in a stage subsequent to the circuit 42. Then, the waveform-judging circuit judges the presence or absence of abnormal ink drop ejection based on the residual vibration waveform, and identifies the detail of the abnormality (i.e. the cause of ink plugging) when an abnormality is judged to be present.

As described above, according to the second embodiment of the invention, in the case where the detection of abnormal ejection of the nozzle 24 of the ink-jet head 20 is to be performed, a charge is left in the electrostatic actuator 22 after the operation of ejecting ink drops, thereby making it possible to detect the change of the residual vibration of the vibrating plate 21. Thus, abnormal ejection (missing dot) can be detected.

Therefore, the second embodiment can eliminate the need for a special sensor such as a photosensor and improve the reliability of detection accuracy for abnormal ink drop ejection even with its relatively simple arrangement like the first embodiment.

1. An apparatus for ejecting liquid drops, comprising:
a head for ejecting liquid drops having
a vibrating plate,
an electrostatic actuator for displacing the vibrating plate, the actuator including the vibrating plate,
a cavity filled with a liquid and having an internal pressure increased and decreased according to a displacement of the vibrating plate, and
a nozzle in communication with the cavity for ejecting the liquid as liquid drops in response to an increase and a decrease in the internal pressure;
a driving unit for outputting a predetermined drive signal for driving the electrostatic actuator;
a residual vibration-detecting unit for detecting a residual vibration of the vibrating plate by a terminal voltage of the electrostatic actuator; and
a connection-switching unit for connecting the electrostatic actuator to said driving unit to allow said driving unit to drive the electrostatic actuator and switching a connection target of the electrostatic actuator from said driving unit to said residual vibration-detecting unit with a charging voltage remaining in the electrostatic actuator.

2. The apparatus for ejecting liquid drops of claim 1, wherein the drive signal output by said driving unit contains an actuator-charging signal for charging the electrostatic actuator, the actuator-charging signal output subsequently to the original drive signal in addition to an original drive signal for driving the electrostatic actuator.

3. The apparatus for ejecting liquid drops of claim 2, wherein said connection-switching unit is composed of an analog switch, and
when a detection process of ejection failure of the nozzle is performed, said driving unit sequentially outputs the original drive signal and the actuator-charging signal with the analog switch connecting the electrostatic actuator to said driving unit, and then the analog switch switches the connection target of the electrostatic actuator from said driving unit to said residual vibration-detecting unit with a predetermined timing thereby to allow a charge to remain in the electrostatic actuator.

4. The apparatus for ejecting liquid drops of claim 1, wherein said connection-switching unit selectively establishes one of a connection between the electrostatic actuator and said driving unit and a connection between the electrostatic actuator and said residual vibration-detecting unit, and
said connection-switching unit includes a resistor element connected in series with the electrostatic actuator.

5. The apparatus for ejecting liquid drops of claim 4, wherein when a detection process of ejection failure of the nozzle is performed, said driving unit outputs the drive signal through the resistor element to the electrostatic actuator with the connection-switching unit connecting the electrostatic actuator to said driving unit, thereby to cause the electrostatic actuator to be charged and discharged with a time constant depending on a resistance value of the resistor element and a capacitance value of the electrostatic actuator, and
said connection-switching unit switches the connection target of the electrostatic actuator from said driving unit to said residual vibration-detecting unit with a timing concurrently with termination of output of the drive signal thereby to allow a charge to remain in the electrostatic actuator.

6. The apparatus for ejecting liquid drops of claim 4, wherein said connection-switching unit is composed of an analog switch, and
said resistor element makes a resistance when the analog switch is conducting.

7. The apparatus for ejecting liquid drops of claim 1, wherein a change in charging voltage of the electrostatic actuator is induced by the charge remaining in an electrostatic actuator and a capacitance of the electrostatic actuator changed according to the displacement of the vibrating plate, and
said residual vibration-detecting unit detects a residual vibration of the vibrating plate based on the induced change in the charging voltage.

8. A method of detecting abnormal ejection of a head for ejecting liquid drops, comprising the steps of:
performing an operation of ejecting a liquid in a cavity as liquid drops through a nozzle by driving an electrostatic actuator including a vibrating plate with a drive signal and vibrating the vibrating plate;
thereafter, with a charging voltage remaining in the electrostatic actuator, detecting a residual vibration of the vibrating plate by the charging voltage; and
detecting abnormal ejection of the liquid drops based on the detected residual vibration.

9. A method of detecting abnormal ejection of a head for ejecting liquid drops, comprising the steps of.
performing an operation of ejecting a liquid in a cavity as liquid drops through a nozzle by driving an electrostatic actuator including a vibrating plate with a drive signal and vibrating the vibrating plate;
immediately thereafter, supplying an actuator-charging signal to the electrostatic actuator for a predetermined time;
thereafter, inducing a change in charging voltage of the electrostatic actuator by a charge remaining in the electrostatic actuator and a capacitance of the electrostatic actuator changed according to a displacement of the vibrating plate;
detecting a residual vibration of the vibrating plate based on the induced change in the charging voltage; and
detecting abnormal ejection of the liquid drops based on the detected residual vibration.
